(19) United States
(12) Patent Application Publication
(10) Pub. No.: US 2004/0232068 A1
(43) Pub. Date: Nov. 25, 2004

(54) Formation of composite materials with expandable matter

(76) Inventors: Arthur W. Johnston, Atlanta, GA (US); Frank A. Williams, Newnan, GA (US); Kenneth D. Hughes, Alpharetta, GA (US)

Correspondence Address: JOHN S. PRATT, ESQ, KILPATRICK STOCKTON, LLP, 1100 PEACHTREE STREET, ATLANTA, GA, 30309, US

(21) Appl. No.: 10/258,225

(22) PCT Filed: Apr. 20, 2001
(86) PCT No.: PCT/US01/12833

(30) Foreign Application Priority Data
Apr. 21, 2000 (US) 60198951

(51) Int. Cl. B01D 39/00

(52) U.S. Cl. 210/502.1

(57) ABSTRACT

A method for generating composite materials and devices from these materials for the filtration, purification, and processing of fluids, water, or other solutions containing microbiological or chemical contaminants, such as fluids containing cysts, bacteria, and/or viruses and inorganic and/or organic contaminants, where the fluid is passed through or over a composite purification material composed of non-expandable and expandable matter that swell through the absorption of fluid.

### BACKGROUND OF THE INVENTION

1. Field of the Invention

This invention relates generally to composite materials and to devices incorporating these materials which are used in filters for solutions and other fluids. These filters find uses in filtration devices, fluid processing devices (primarily to aqueous solution filters and water purification), devices for emissions treatment of gases and of other aqueous liquids, which remove contaminants from the gas or aqueous liquid solution passed through them. In its more particular aspects, the invention relates to the field of devices that remove chemical and microbiological contaminants, including pesticides, metals, dissolved solids, cysts, bacteria, viruses, and components of these species from water or aqueous solutions.

2. Description of Related Art

Composite materials may be formed by a number of different techniques, such as sintering or firing, melting and cooling, extrusion, and molding. In general composite materials are generated from two or more unique chemical species; one or more species forms a matrix and binds or holds together the other species (a dispersed phase) into a unified form. A number of techniques for fabricating composite materials are known in the art.

Purification, filtration, and processing of water or other aqueous solutions is necessary for many applications, from the provision of safe or potable drinking water to biotechnology applications including fermentation processing and separation of components from biological fluids. Similarly, the removal of microbial organisms from breathable air in hospitals and clean rooms, where ultrapurified air is required, and in environments where the air will be recirculated, such as aircraft or spacecraft, is also an important application for filtration media. In recent years, the need for air filtration and composite purification in the home has become more recognized, and the competing concerns of energy efficiency and indoor air quality have led to numerous air filtration products, such as HEPA filters and the like, that purport to remove small particles, allergens, and even microorganisms from the air.

There are many well-known methods currently used for water purification, such as distillation, ion-exchange, chemical adsorption, filtering or retention, which is the physical occlusion of particulates. Particle filtration may be completed through the use of membranes or layers of granular materials, however in each case the pore size of the material and the void space between the granular materials controls the particle size retained. Additional composite purification media include materials that undergo chemical reactions, which alter the state or identity of chemical species in the fluid to be purified. Examples include emission control based upon metal catalysts.

Materials that are highly efficient at removing, immobilizing, and converting chemical species and removing or inactivating microorganisms have numerous applications, but particular areas of application include generating purified water, processing chemical streams, and chemical stream conversion with catalysts, biotechnology, and fermentation processes. Composite materials are currently useful in many stages of the processing of fluids generated in each of these fields.

In many practical fluid treatment and processing applications a combination of techniques and technologies are required in order to completely treat or process the fluid stream. As example in the treatment of water for drinking and food applications both chemical and microbiological purification are required before consumption. Combinations of technologies may be implemented by combining functions in a single device or using several devices in series where each performs a distinct function. Examples of combining technologies include the use of mixed ion exchange resins that remove both negative and positively charged species and the use of mechanical filtration in conjunction with chemical or radiative oxidation methods.

In the fluid treatment applications listed previously containers of granular particles are used to treat and process fluids, liquids and gases, in order to convert components of the fluids into different species, remove contaminants and/or to isolate valuable components. Particularly it is well known to use granular absorption materials for removing microorganisms as well as organic and inorganic chemical contaminants. Granular adsorption materials include ion exchange resins, and activated and inactivated carbonaceous materials. It is also known to use naturally occurring minerals such as apatite, tricalcium phosphate and alumina based ores and some derivatives thereof in granular, particulate or fiber form as a water treatment material. An example of the use of apatite and alumina includes the commercial products available from WaterVisions International Inc. and the prior art described in patent application (U.S. Pat. No. 5,755,969). These materials address both the chemical and microbiological contaminants in water systems.

One of the most common methods of applying granular fluid treatment materials involves the loading or containment of the treatment particles in a suitable housing fitted with screens that do not allow the loss of the granular material (particles). Many different devices may be fabricated with the contained particulate material. These devices are used by consumers and commercial entities for chemical analysis, chemical stream processing, waste and exhaust treatment, biotechnology and drinking water treatment.

Although devices employing granular materials can be very simple in design they rarely provide sufficient performance for the most critical applications. For example, simple point-of-use fluid composite purification devices, such as water filters attached to in-house water supply conduits do not provide microbiological water purification at levels required for safe consumption.

Reasons for the lack of performance of granular materials and devices that contain granular materials involves the mobility of the granular material inside the container over time. Particle contact and subsequent grinding leads to particle size reduction. Contaminants contained in the fluid stream over time foul particle surfaces which leads to particle aggregation. The ultimate result of these situations is fluid channeling and bypass of the granular fluid treatment materials.

Methods for improving fluid-particle contact and limiting fluid bypass have focused on technology that provides particle immobilization. Particle immobilization has been obtained by the fibrillation of Teflon (U.S. Pat. Nos. 5,071,610 and 4,194,040) and by use of polymer binders as that described in U.S. Pat. Nos. 5,249,948, 5,189,092, 5147722, 5019311, and by using materials produced by 3M Corp., Fibredyne Inc. and WaterVisions International Inc. In each of these examples, however, expensive industrial equipment is required for generation of the composite materials.

Additionally, significant technical know-how and expertise is required for large scale production of usable composite materials. Finally, these technologies are difficult to universally apply to the immobilization of different types of fluid treatment granular materials, mixtures of fluid treatment materials, and in addressing the wide range of fluid treatment situations that currently exist.

Therefore, there remains a need in the industry for a way to simply and rapidly immobilize different fluid treatment granular materials so that fluid contact with them is improved. Additionally, these composite materials must inexpensively facilitate the fabrication of different shape and size devices for the wide range of fluid treatment situations that currently exist.

Organic superabsorbent materials currently have two primary uses. These include use in personal care/hygiene products, such as diapers, incontinence products and feminine care products, and use as components of protective coatings where the superabsorbent stops water penetration, for example, in conjugation with electrical conductors. Secondary applications include use as ion exchange materials for water treatment, and in agriculture soil additives where water is retained by the absorbent for plant use. Inorganic expandable matter, such as bentonite, is used in formulations for sealing cracks and holes in ponds and fluid containment structures. In each of these prior applications the expanding matter is used to either remove water from a location, thereby drying the location, to stop the penetration of water, e.g. to keep water from moving through a shielding that protects electrical components, or to store or sequester water for later use or disposal. None of these uses relate to composite materials that have been fabricated for the purpose of facilitating fluid passage and chemical/biological manipulation under controlled situations.

### SUMMARY OF THE INVENTION

To this end, the present inventors have discovered a novel composite materials for fluid treatment and a new mechanism for generating them. Composite materials are formed by combining material that does not expand substantially in the presence of the fluid to be treated or some other fluid and a material that does expand substantially in the presence of the fluid to be treated or some other fluid. The expanding material forms a matrix that locks into position both the expanding and non-expanding material thereby forming a composite. The invention is applicable to all types of fluid insoluble particles and mixtures thereof. The invention can be used in a wide range of devices with significant consumer and industrial application. In a preferred application the composite materials may be fabricated in the form of blocks, tubes, sheets, or films, and are used to modify the properties of fluids, which pass over or through the composite material generated with both types of matter. At least, the non-expanding material is one that will remove, transform, or inactivate one or more contaminates or undesired components.

As described above, the effectiveness of fluid treatment devices generated with materials in loose form can be compromised by channeling and by-pass effects caused by the pressure of fluid, such as water and aqueous solutions, flowing through the treatment material, as well as by particle erosion and aggregation. Because chemical species, as well as viruses and bacteria, are removed, transformed, or inactivated by intimate contact with the treatment material, even relatively small channels or pathways in the granular material formed over time by water pressure, water flow, particle erosion, or particle aggregation are sufficient to allow passage of undesirable chemical and microbiological contaminants through the treatment device.

This invention solves this problem by providing porous composite fluid treatment materials, devices for fluid treatment containing these materials, and methods for making them that can process or remove chemical contaminants such as organics and inorganics, as well as microbiological contaminants including bacteria, cysts, and viruses from the fluid stream, while eliminating fluid channeling and contaminate by-pass by the combination of the non-expanding and expanding treatment materials which occurs in the device.

One aspect of the invention is a device and method for the treatment, purification, and filtration of aqueous fluids, in particular water (such as drinking water or swimming or bathing water), or other aqueous solutions (such as fermentation broths and solutions used in cell culture), or gases and mixtures of gases, such as breathable air, found in clean rooms, hospitals, diving equipment, homes, aircraft, or spacecraft, and gases used to sparge, purge, or remove particulate matter from surfaces. The method may be easily adapted to process streams that use catalysts such as those found in the petroleum industry and the gas-emission clean-up industries, which convert gases that are toxic or environmentally unacceptable to non-harmful species. The use of the devices according to the invention can result in the removal of an extremely high percentage of microbiological contaminants, including bacteria and viruses and components thereof. In particular, the use of the device and method of the invention results in purification of water to a level that meets the EPA standards for designation as a microbiological water purifier.

In typical embodiments, the invention relates to a composite purification material for fluids that contain particulate carbon, apatite, alumina or aluminosilicate materials and is in the form of a porous material as the result of the presence of the expanding material. Typically the carbon is activated through standard practices. Typically, at least a portion of this apatite is in the form of hydroxylapatite, and has been obtained from natural sources, e.g., as bone char, or from synthetic sources such as the mixing of calcium and phosphate containing compounds. Typically, at least a portion of the aluminosilicate is in the form of bauxite or alumina, and has been obtained from natural or synthetic sources. Also typically, the expanding material is a polymeric or oligomeric material that is capable of expanding sufficiently on contact with water or some other fluid that it immobilizes the particulate apatite or aluminosilicate in a composite material structure. This allows the composite purification material to take any desired shape, e.g., a shape suitable for inclusion into the housing of a filtration device, which provides for fluid inflow and outflow. Such a device forms another embodiment of the invention. In addition to maintaining the carbon, apatite, alumina, or aluminosilicate particles immobilized in a unitary composite material, the polymeric or oligomeric expanding material also provides desirable functional characteristics to the device, e.g., rendering it rigid or flexible, depending upon the type and amount of polymeric or oligomeric expanding material used. Further still the expandable material can provide additional purification of the water.

In another embodiment, the invention relates to a composite purification material for fluids that are in the form of a sheet or membrane, containing the particulate carbon, apatite, alumina, or aluminosilicate immobilized with expanding matter.

The invention also relates to methods of filtering fluids, such as water, aqueous solutions, and gases, to remove a large proportion of one or more types of chemical contaminants and microorganisms contained therein, by contacting the fluid with the composite purification material of the invention. In a particular aspect of this embodiment of the invention, this contacting occurs within the device described above, with the unfiltered fluid flowing through an inlet, contacting the composite purification material in one or more chambers, and the filtered fluid flowing out of the chamber through an outlet and having a significantly decreased concentration of microorganisms and/or chemical contaminants.

Composite purification materials prepared with the invention can be used to purify drinking water, to purify water used for recreational purposes, such as in swimming pools, hot tubs, and spas, to purify process water, e.g. water used in cooling towers, to purify aqueous solutions, including but not limited to, fermentation broths and cell culture solutions (e.g., for solution recycling in fermentation or other cell culture processes) and aqueous fluids used in surgical procedures for recycle or reuse, and to purify gases and mixtures of gases such as breathable air, for example, air used to ventilate hospital or industrial clean rooms, air used in diving equipment, or air that is recycled, e.g., in airplanes or spacecraft, as well as gases used to sparge, purge or remove volatile or particulate matter from surfaces, containers, or vessels. The method may be easily adapted to process streams that use catalysts, such as in the petroleum industry and the gas-emission clean-up industries. Composite purification materials of the invention and devices generated with these materials have the additional advantage of being able to make use of readily available carbonaceous, apatite and/or aluminosilicate materials, including those obtained from natural sources, while still maintaining high chemical and microbiological purification efficiency.

In yet another embodiment of the invention, the fluid purification materials of the invention, namely the non-expanding and expanding material and formed into a composite material or sheet, can be used as an immobilization medium for microorganisms used in biotechnology applications such as fermentation processes and cell culture. In this embodiment, microorganisms are immobilized in the composite material, and biological process fluids, such as nutrient broths, substrate solutions, and the like, are passed through the immobilization material of the invention in a manner that allows the fluids to come into contact with the microorganisms immobilized therein, and effluent removed from the material and further processed as needed.

In yet another embodiment of the invention, the fluid purification materials of the invention, namely non-expanding and expanding matter and formed into a composite material or sheet, can be used as an immobilization medium for catalysts used in chemical and biotechnology applications such as fermentation processes, industrial emission control, petroleum processing, and chemical stream processing. In this embodiment, chemical or biological process fluids, such as gas streams, hydrocarbon containing solutions, and the like, are passed through the immobilization material of the invention in a manner that allows the fluids to come into contact with the catalysts immobilized therein. The catalysts cause the reactive species in the fluid to undergo reaction, thereby reducing their concentration in the effluent, which can then be removed from the material and further processed as needed.

### DETAILED DESCRIPTION OF SPECIFIC EMBODIMENTS OF THE INVENTION

As indicated above in the Summary, in its general embodiments the invention relates to a fluid composite purification material in the form of a composite material filter containing granulated carbon, apatite, alumina, or aluminosilicates, with expanding material, which is typically a polymeric material that expands when in contact with water or some other fluid. In a particular aspect of this embodiment, the invention relates to a composite material filter that contains a mixture of a distributed phase containing one or more of granulated apatite and derivatives thereof, granulated activated charcoal (GAC), alumina, or other adsorptive media such as bauxite, alumina silicates, or ion exchange resins, in combination with immobilizing matrix phase containing material that will expand in volume when in contact with water or other fluid, such as a polyacrylic acid material. The distributed phase becomes fixed by the expanding matter, and that channeling from flow during fluid treatment cannot occur. The fluid composite purification material of the invention can be produced simply by mixing particles of each type together in random fashion. The mixture of expanding material and non-expanding fluid treatment particles are then formed into a block, sheet, film, or coating when fluid is introduced to the material. Devices may be produced in any shape or size and may be rigid or flexible. The pore size of the filter composite material influences flow rates of the fluid through the filter, and is a function of the size of the granular particles incorporated into the filter composite material as well as the relative ratio of expanding and nonexpanding materials. As used herein, the term “composite material” does not denote any particular geometrical shape. Nonlimiting examples of “composite materials” as this term is intended to be used include tubes and annular rings, as well as more conventional geometrical solids. Material formed into flexible composite materials is particularly suitable for use in pipes or tubes that serve as the fluid filter medium.

One of the desirable features of purification materials generated with the invention is that devices may be formed into any desired shape. This provides ease of handling and extremely high scalability. For example, a composite purification material may be formed into a monolith or wrapped sheet that fits into conventional housings for filtration media. It can be shaped to provide purification as part of a portable or personal water or breathing filtration system. The material may be formed into several different pieces, through which water flows in series or in parallel. Sheets or membranes of the composite purification material may also be formed. The rigidity of the purification material and subsequent devices, whether in block form or in sheet/membrane form, may be altered through inclusion of flexible support structures that contain the expanding and non-expanding material.

Particle Immobilization or Locking Mechanism:

The expanding material may be in the form of particles ranging in size from 0.1 microns through 10 millimeters, fibers with diameters of 0.5 microns through 10 millimeters, or sheets of woven or non-woven materials that have thicknesses of 0.5 microns through 10 millimeters. In a preferred application expanding particles are used to form the composite. It is also preferred that the expanding particles are similar in size to the particles of non-expanding matter, to reduce separation of particle types.

While not wishing to be bound by any theory, it is believed that the mechanism for immobilizing both particle types involves the swelling of the expandable matter upon contact with a fluid, typically water or an aqueous solution. This generates significant physical stresses on all particles and on structural supports. The force generated by the expandable particles remains present as long as these particles remain partially or fully swollen. In a preferred embodiment the expanding particles are restricted from fully swelling by the presence of the non-swelling particles and by the presence of support structures.

Surface Contact Between Non-Expanding and Expanding Matter:

In other materials, surface contact between the “binder” and the “functional” particles has included entrapment as well as “surface-point-binding.” In this invention, intimate interaction between particle types may be generated using a number of different techniques which may include force point pressure electrostatic interactions between surfaces with different electrical charge characteristics, hydrophobic binding between materials with similar surface polarities and molecular structure, molecular locking mechanisms that include specific molecular binding sites or receptors, as well as known chemical reactions that form permanent or transient chemical bonds. For example, the contact points between the swellable or expandable material and the non-expanding material may involve ionic interaction between acid moieties on one of the materials and divalent species (such as calcium, magnesium, copper, silver, etc.) or acid moieties and multivalent species (such as iron, aluminum, chromium, and other multivalent metal ions).

Spatial Location of the Different Types of Material:

The spatial locations of the two particle types may vary. In preferred embodiments the swelling particles are present randomly mixed with the non-swelling particles, isolated on the periphery of the non-expanding particles, or contained in the support structure used to contain the non-expanding particles. It should be obvious to anyone familiar with the art that fibrous materials and sheets of woven and non-woven materials with the ability to expand may also be used in a fashion that provides similar results.

Porosity of the Composite Materials:

It is well known in the art of preparing composite materials that pore density and size are important material parameters that can vary with the use to which the material will be put. The passage of fluids, liquids and gases, through a material is dependent upon the pore characteristics. In the described technology the pore characteristics in the composite material are manipulated and “tuned” by controlling the particle size, fiber dimensions, or sheet thickness of the expanding and nonexpanding material as well as the ratio of expanding and non-expanding material. The immobilization of all particles by the presence of the expanding particles serves to generate composite materials where the pores or void spaces are located between similar or different particle types. It should be noted that each of the particulate materials will have a characteristic pore structure which will assist and take part in the specific fluid treatment application.

Preferred and Applicable Non-Expanding Material:

The non-expanding particles that may be immobilized in this art include activated and inactivated carbons, metal oxides such as alumina, titanium dioxide, and catalytic materials generated from these components and those experienced in the art will recognize the deposition of molecules containing active sites which include metals and atoms and nanocomposites of metals and semimetals on the surface of support materials is an obvious extension of the invention.

Other natural and synthetic minerals may be immobilized in this technology including those known as aluminosilicates such as bauxites, kaolin, and clinoptilolite, and phosphate containing minerals such as the apatites. Specifically phosphate minerals including hydroxyapatite and materials containing hydroxyapatite including Bone Char are applicable.

Pure metal particles as well as alloys including brass, copper, zinc, and the precious metals may be immobilized with the described art.

Additionally mixtures of all of these particle types may be immobilized with the same general method. Thus metal coated oxides which are used as catalysts (platinum and rhodium) containing materials may be immobilized. Synthetic particles including ion-exchange resins, drug delivery particles, and slow release fertilizer type particles may be immobilized in a wide range of mixtures.

Preferred and Applicable Expanding Fluid Treatment Matter:

Material that expands as a result of absorption of fluids (either gases or liquids) can be generated from a range of synthetic and natural materials. These materials include synthetic and natural polymers, as well as certain clays.

The class of materials known as “superabsorbents” is particularly suitable in this regard. Superabsorbents are natural, synthetic, or mixed polymers which are not fully cross-linked. They may be classified as polyelectrolyte or nonpolyelectrolyte types as well covalent, ionic, or physical gelling materials. These materials have the capacity to absorb many times their own volume in fluid. Examples of synthetic materials include polyacrylic acids, polyacrylamides, poly-alcohols, polyamines, and polyethylene oxides. Natural sources include cellulose derivatives, chitins, and gelatins. Additionally mixtures of synthetic polymer and natural polymers either as distinct chains or in copolymers may be used to generate these absorbent materials. Examples include starch polyacrylic acid, polyvinyl alcohols and polyacrylic acid, starch and polyacrylonitrile, carboxymethyl cellulose, alginic acids carrageenans isolated from seaweeds, polysaccharides, pectins, xanthans, poly(diallyldimethylammonium chloride), polyvinylpyridine, polyvinylbenzyltrimethylammonium salts. As those experienced in the art will understand the process of crosslinking the polymer chains derived from either source or from both sources, are variable and will effect the magnitude of fluid absorption, the types of fluids that can be absorbed. Additionally those experienced will understand that molecular characteristics such as polymer chain molecular weight and distribution will effect performance, and will know how to modify these parameters to vary the properties of the resulting composite consistent with the basic tenets of the invention.

Inorganic sources of expanding particles include bentonite and other clays and aluminosilicates that increase in volume when fluid is absorbed.

Other methods for the immobilization of “functional” particles use synthetic polymer binders that are either fibrillated, or melted to provide a means for entrapping and “point-bonding” of particulate materials. These methods require complex and costly equipment and significant know-how and expertise to perform properly. In these applications the binder serves a single purpose, which is to immobilize the “functional” particles.

The material of this invention requires no expensive instrumentation or equipment, or significant expertise, as non-expanding and expanding particle types of any ratio and composition can simply be mixed and added to a supporting structure of sufficient size and strength to contain the expanded composite. This simplifies the manufacture of many different composite materials in many shapes and sizes. By contrast, the use of melted polymers (thermoplastics) as heretofore known, requires significant understanding of polymer characteristics, and expensive equipment such as extruders, molds, injection molds and the like. In order to change the shape and size of the composite material, new extruder dies and/or molds are required at considerable expense. These hardware modifications are not required in the invention.

The invention has other advantages (in addition to being low cost and simple in application). These include the elimination of a heating step required to prepare liquid binders from thermoplastics and elastomers, and the quick development of new products having differing parameters or properties. For example, when using extruders the screw speed, barrel temperature and die shape and size must be optimized for each extruded material. Significant trial-and-error and technical know-how is required to generate such materials in stable and consistent fashion.

This trial-and-error approach is not needed with the material of the invention. Current scientific knowledge provides a clear understanding for generating intimate contact between expanding and non-expanding matter.

The invention is also advantageous because in many applications, the amount of expanding material is less than the amount of binder used in prior materials. This increases the amount of non-expanding material present per unit volume. In applications where the expanding material serves no role other than immobilization of the more functional material, this is a significant advantage. In the several embodiments described herein, the levels of expanding material are between 1 and 5% and have been demonstrated at 2 to 2.5% based upon the combined weight of expanding and nonexpanding material. This is much lower than the cited prior art which uses binder levels between 10 and 30 percent and usually between 15 and 25 percent based on the filter composition.

However, the present invention also allows for additional functionality besides merely “binding” the non-expanding material. The expanding material which serves to immobilize is also functional in that it may be swelled with fluid that contains active species or molecules to be delivered to the fluid stream that passes through the composite material. Those of skill in the art will recognize that solutions of drugs, pharmaceuticals and water conditioners may be used. Additionally, the same chemical functional groups that provide intimate contact between different particle types and structural supports may also serve in an active capacity facilitating ion exchange and particulate binding. In a particular embodiment, superabsorbents based upon polyacrylic acid and polyacrylamide are used. These materials have one or more surface charged functional groups that provide additional chemical and biologically active sites. As examples, the presence of positively or negatively charged groups allows for the binding of drugs and pharmaceuticals, control of concentration or release of bound species, including metals, ions, and particles that provide bacteriostatic or antiviral functions, the retention of dissolved solids from a liquid stream, and the retention of bacteria and viruses in the water or other fluid.

An additional advantage of the invention relates to the temperature requirements for the method for making the composite material. The invention does not require the binder particles to be melted or fibrillated in order to immobilize the non expanding particles. This is in contradistinction to known processes, which are very temperature sensitive. As a result, the composite materials can be formed at any temperature where both particle types and the fluid used for swelling are stable. Composite materials can thus be prepared at very low temperatures, which facilitates the inclusion of chemical and biological species that are temperature sensitive.

While not wishing to be bound by any theory, it is believed that the composite purification material of the invention achieves its unusually high efficiency in removing chemical contaminants and microorganisms from fluids partly as the result of the immobilization of the non-expanding treatment particles with the expanding material, and the necessity for fluid flowing through the composite purification material to follow an extended and tortuous path therethrough, instead of forming channels through the composite purification material as occurs in prior granular purification/filtration materials. This extended path ensures that the fluid contacts a larger proportion of the surface area of the particles, especially of the nonexpanding treatment particles, as well as preventing sustained laminar flow of the fluid through the purification material. This latter effect is believed to help prevent laminae of fluid containing chemicals and microorganisms from avoiding sustained contact with granular particles in the filter device. After the composite purification material has been in service for a period of time, additional filtration by occlusion will occur as adsorbed material accumulates in the pores of the composite purification material.

Those familiar with the art of fluid filtration will understand that the pore size and physical dimensions of the composite purification material may be manipulated for different applications and that variations in these variables will alter flow rates, back-pressure, and the magnitude of chemical and/or microbiological contaminant removal. Likewise those knowledgeable in the art will recognize that variations in the percentages of each component of the composite purification material will provide variable utility. For example, increasing the percentage of expanding matter in the composite purification material will result in a material having an increased pressure drop and lower flow, while decreasing the percentage of expanding matter will result in a composite purification material having flow rate and pressure drop properties closer to that of granular materials.

In one particular embodiment of the invention, the nonexpanding treatment particles contain apatite, used in the form of bone char, and granulated activated carbon (GAC) present in approximately equal amounts with the percentage of expanding material kept to a minimum. It will be recognized, however, that the apatite used in the invention may be obtained or derived from other natural or synthetic sources, and that mixtures of these different derivatives can provide differences in the properties of the composite purification material. For example, increased levels of silica in the ore to the filter composite material will result in decreased reduction of fluoride in the effluent water if water is used as the fluid. Calcining, purification, and heat treatments usually increase surface area and thus ion removal capabilities. This can be useful in, e.g. purifying fluorinated water in such a way as to maintain desirable ion levels therein. Adding fluoride to the filter composite material will result in a decreased reduction of fluoride in the effluent water, if water is used as the fluid. This can be useful in, e.g. purifying fluorinated water in such a way as to maintain desirable fluorine levels therein. Fluoride in the filter material may be obtained either by inclusion of fluorapatite-rich apatite mixtures, inclusion of fluoride salts and compounds, or by pre-conditioning the composite purification material by passing through fluoride-containing solutions, which are retained by the expanding particles.

In another particular embodiment of the invention, the nonexpanding treatment particles contain alumina, bauxite, kaolin or other aluminosilicate containing ore, and granulated activated carbon (GAC) present in approximately equal amounts with the percentage of expanding material kept to a minimum. It will be recognized, however, that the alumina used in the invention may be obtained or derived from other natural or synthetic sources, and that mixtures of these different ores can provide differences in the properties of the composite purification material. For example, increased levels of silica in the ore to the filter composite material will result in decreased reduction of fluoride in the effluent water if water is used as the fluid. Calcining, purification, and heat treatments usually increase surface area and thus ion removal capabilities. This can be useful in, e.g. purifying fluorinated water in such a way as to maintain desirable ion levels therein. Adding fluoride to the filter composite material will result in a decreased reduction of fluoride in the effluent water, if water is used as the fluid. This can be useful in, e.g. purifying fluorinated water in such a way as to maintain desirable fluorine levels therein. Fluoride in the filter material may be obtained either by inclusion of fluorapatite-rich apatite mixtures, inclusion of fluoride salts and compounds, or by pre-conditioning the composite purification material by passing through fluoride-containing solutions, which are retained by the expanding particles.

Those experienced in the art will also understand that different crystal lattices are possible for apatite and aluminosilicate ores and for other adsorbent materials that can be used in the invention, and that these variations will yield differences in properties of the resulting composite purification material, as certain crystal structures improve and inhibit interactions with chemicals, microorganisms, and other biological materials. These differences in properties result from differences in interactions between the microorganisms and other biological materials and the chemical contaminants with the different positive and negative ions that are included in the crystal structure. The expanding material is capable of immobilizing all crystal types.

In another embodiment of the invention, the composite purification material is constructed to withstand sterilization. Sterilization processes include thermal processes, such as steam sterilization or other processes wherein the composite purification material is exposed to elevated temperatures or pressures or both, resistive heating, radiation sterilization wherein the composite purification material is exposed to elevated radiation levels, including processes using ultraviolet, infrared, microwave, and ionizing radiation, and chemical sterilization, wherein the composite purification material is exposed to elevated levels of oxidants or reductants or other chemical species, and which is performed with chemicals such as halogens, reactive oxygen species, formaldehyde, surfactants, metals and gases such as ethylene oxide, methyl bromide, beta-propiolactone, and propylene oxide. Additionally, sterilization may be accomplished with electrochemical methods by direct oxidation or reduction with microbiological components or indirectly through the electrochemical generation of oxidative or reductive chemical species. Combinations of these processes are also used on a routine basis. It should also be understood that sterilization processes may be used on a continuous or sporadic basis while the composite purification material is in use.

In general, the invention comprises a method and a means for fabricating devices for the filtration and purification of a fluid, in particular an aqueous solution or water, to remove organic and inorganic elements and compounds present in the water as particulate material. In particular, the device and method can be used to remove chemicals such as organics, pesticides, and heavy metals, as well as microbiological contaminants, including bacteria and viruses and components thereof, from water destined for consumption and use by humans and other animals. The method and devices of the invention are particularly useful in these applications where the reduction in concentration of microbiological contaminants obtainable with the invention addresses the EPA standards for microbiological water purification, and also significantly exceeds the effectiveness of other known filtration and composite purification devices incorporating granulated adsorption. In a particular embodiment of the invention, the composite purification material is a porous composite material formed by granulated or particulate apatite, which is defined herein to include hydroxylapatite, chlorapatite, and/or fluorapatite, and other optional adsorptive granular materials, described in more detail below, such as granulated activated charcoal (GAC), alumina, and bauxite, retained with a polymeric matrix of expanding material. In the method corresponding to this particular embodiment, the microbiological contaminants are removed from the water when the water is forced through the porous composite material by water pressure on the influent side, or by a vacuum on the effluent side, of the filter composite material.

In an embodiment of the invention where the composite purification material is composed of a mixture of hydroxylapatite and an adsorptive granular filter media, for example GAC, these components can be dispersed in a random manner throughout the composite material. The composite purification material can also be formed with spatially distinct gradients or separated layers, for example, where the hydroxylapatite and GAC granules are immobilized in separate layers using expanding matter, for example a polymer superabsorbent such as polyacrylic acid or polyacrylamide or the like, so that movement of the hydroxylapatite and GAC particles is precluded and detrimental channeling effects during fluid transport through the composite material are prevented. If the components reside in separate locations the fluid flow is sequential through these locations.

In a particular example of this embodiment, at least a portion of the apatite present is in the form of hydroxylapatite, which is added in the form of bone charcoal or bone char. An example of a suitable material is that designated as BRIMAC 216 and sold by Tate & Lyle Process Technology. The material may be ground to a desirable particle size, e.g., 80-325 mesh. A typical analysis of this material shows 9-11% carbon, up to 3% acid insoluble ash, up to 5% moisture, from approximately 70-76% hydroxylapatite (tricalcium phosphate), 7-9% calcium carbonate, 0.1-0.2% calcium sulfate and less than 0.3% iron (calculated as Fe₂O₃). This material is produced in a granular form having a total surface area of at least 100 m²/g, a carbon surface area of at least 50 m²/g, pore size distribution from 7.5-60,000 nm and pore volume of 0.225 cm³/g. The element binding characteristics of this material have been reported and include chlorine, fluorine, aluminum, cadmium, lead, mercury (organic and inorganic), copper, zinc, iron, nickel, strontium, arsenic, chromium, manganese, and certain radionuclides. The organic molecule binding capabilities have been reported for complex organic molecules, color-forming compounds, compounds that add taste to fluids, compounds that add odors to fluids, trihalomethane precursors, dyestuffs, and tributyltin oxide.

The bone char (containing hydroxylapatite) and the GAC are in this example mixed in approximately equal amounts with the minimal amount of expanding matter material necessary to compose a monolithic composite purification material. However, the concentrations of HA, of GAC, and of expanding matter are substantially variable, and materials having different concentrations of these materials may be utilized in a similar fashion without the need for any undue experimentation by those of skill in the art. In general, however, when GAC is used as the additional adsorbent material, its concentration in the mixture is generally less than 50% by weight, based upon the weight of the composition before any drying or compacting. Additionally, adsorbents other than GAC may be substituted completely for, or mixed with, the GAC in a multicomponent mixture. Examples of these adsorbents include various ion-binding materials, such as synthetic ion exchange resins, zeolites (synthetic or naturally occurring), diatomaceous earth, and one or more other phosphate-containing materials, such as minerals of the phosphate class, in particular, minerals of the apatite group.

In particular, minerals of the apatite group, i.e., a group of phosphates, arsenates, and vanadates having similar hexagonal or pseudohexagonal monoclinic structures, and having the general formula X₅(ZO₄)₃ (OH, F, or Cl), wherein each X can independently be a cation such as calcium, barium, sodium, lead, strontium, lanthanum, and/or cerium cation, and wherein each Z can be a cation such as phosphorus, vanadium, or arsenic are particularly suitable for the invention.

Additionally, polymeric materials used for ion-binding including derivatised resins of styrene and divinylbenzene, and methacrylate may be used. The derivatives include functionalized polymers having anion binding sites based on quaternary amines, primary and secondary amines, aminopropyl, diethylaminoethyl, and diethylaminopropyl substituents. Derivatives including cation binding sites include polymers functionalized with sulfonic acid, benzenesulfonic acid, propylsulfonic acid, phosphonic acid, and/or carboxylic acid moieties.

Natural or synthetic zeolites may also be used or included as ion-binding materials, including, e.g., naturally occurring aluminosilicates such as clinoptilolite, bauxite, kaolin and others.

Suitable expanding materials include any polymeric material capable of immobilizing the particulate materials and maintaining this immobilization under the conditions of use. They are generally included in amounts ranging from about 0.1 wt % to about 99.9 wt %, more particularly from about 0.25 wt % to about 10 wt %, based upon the total weight of the composite purification material. Suitable polymeric materials include both naturally occurring and synthetic polymers, as well as synthetic modifications of naturally occurring polymers. The polymeric expanding materials generally include one or polyacrylic acids, polyacrylamides, poly-alcohols, polyamines, and polyethylene oxides. Natural sources include cellulose derivatives, chitins, and gelatins. Additionally mixtures of synthetic polymer and natural polymers either as distinct chains are in copolymers may be used to generate these absorbent materials. Examples include starch polyacrylic acid, polyvinyl alcohols and polyacylic acid, starch and polyacrylonitrile, carboxymethyl cellulose, alginic acids carrageenans isolated from seaweeds, polysaacharides, pectins, xanthans, poly(diallyldimethylammonium chloride), polyvinylpyridine, polyvinylbenzyltrimethylammonium salts or a combination thereof, depending upon the desired mechanical properties of the resulting composite purification material.

In general, polymers absorbing more than 1 gram of fluid to each gram of polymer can be particularly mentioned as suitable. Those of skill in the art will recognize that any polymeric matter that expands in volume as fluid is absorbed can be used in the invention in an analogous manner.

In general inorganic clays and aluminosilicates may be used as the source of expanding matter. Examples include bentonite and similar clays. Those of skill in the art will recognize that any inorganic matter that expands in volume as fluid is absorbed can be used in the invention in an analogous manner and that in most cases inorganic materials will absorb less fluid per unit weight.

Naturally occurring and synthetically modified naturally occurring polymers suitable for use in the invention include, but are not limited to, natural and synthetically modified celluloses, such as cotton, collagens, and organic acids. Biodegradable polymers suitable for use in the invention include, but are not limited to, polyethylene glycols, polylactic acids, polyvinylalcohols, co-polylactideglycolides, starch, carboxymethyl cellulose, alginic acids, carrageenans isolated from seaweeds, polysaccharides, pectins, xanthans, and the like.

In the specific embodiment of a filter material that may be sterilized, the apatite used is in the form of bone char, and GAC material is present in approximately equal amounts with the percentage of expanding matter material kept to a minimum. The expanding matter used must be stable to the temperature, pressure, electrochemical, radiative, and chemical conditions presented in the sterilization process, and should be otherwise compatible with the sterilization method. Examples of expanding matters suitable for sterilization methods involving exposure to high temperatures (such as steam sterilization or autoclaving) include polyacrylic acid and derivatives thereof and incorporating various counter ions. Composite purification materials prepared with these expanding matters can be autoclaved when the expanding matter polymers are prepared according to known standards. Desirably, the composite purification material is stable to both steam sterilization or autoclaving and chemical sterilization or contact with oxidative or reductive chemical species, as this combination of sterilizing steps is particularly suitable for efficient and effective regeneration of the composite purification material.

In the embodiment of the invention wherein sterilization is at least in part conducted through the electrochemical generation of oxidative or reductive chemical species, the electrical potential necessary to generate said species can be attained by using the composite purification material itself as one of the electrodes. For example, the composite purification material, which contains polymeric expanding matter, can be rendered conductive through the inclusion of a sufficiently high level of conductive particles, such as GAC, carbon black, or metallic particles to render a normally insulative polymeric material conductive. Alternatively, if the desired level of carbon or other particles is not sufficiently high to render an otherwise insulative polymer conductive, an intrinsically conductive polymer or metal may be used as is or blended with the expanding matter. Examples of suitable intrinsically conductive polymers include doped polyanilines, polythiophenes, and other known intrinsically conductive polymers. These materials can be incorporated with or as the expanding material in sufficient amount to provide a resistance of less than about 1 kΩ, more particularly less than about 300 Ω.

The composite purification material of the present invention may be in the form of a block, but need not be, and may also be formed into a sheet or film. This sheet or film may, in a particular embodiment, be disposed in a woven or nonwoven web of, e.g., a polymer. The polymer used to form the woven or nonwoven web may be any thermoplastic or thermosetting resin typically used to form fabrics. Polyolefins, such as polypropylene and polyethylene are particularly suitable in this regard.

The efficiency of composite purification materials generated by the method of the invention in reducing microbiological contaminants is a function of the pore size within the composite material and the influent fluid pressure, as is the flow rate of the fluid through the material. At constant fluid pressure, flow rate is a function of pore size, and the pore size within the composite material can be regulated by controlling the size of the HA and GAC granules—large granule size providing a less dense, more open composite purification material which results in a faster flow rate, and small granule size providing a more dense, less open composite purification material which results in a slower flow rate. A composite material formed with relatively large HA granules will have less surface area and interaction sites than a composite material formed with smaller granules, and therefore the composite purification material of large granules must be of thicker dimension to achieve equal removal of microbiological contaminants. Because these factors are controllable within the manufacturing process, the composite purification materials can be customized by altering pore size, composite material volume and composite material outer surface area and geometric shape to meet different application criteria. Average pore size in a particular embodiment is kept to below several microns and more particularly to below about one micron, to preclude passage of cysts. It should be noted that the pore size described herein does not refer to the pores within the adsorbent or absorbent particles themselves, but rather to the pores formed within the composite purification material when the particles are immobilized together by the expanding material.

The method of making the material of the invention, in its most general aspect, involves combining the non-expanding materials (and optional additional particulate adsorbent material(s)) with the expanding material and adding the combination to an appropriate container. At some point, a fluid capable of swelling the expanding material is added to the combination, with the result that the combination forms a composite. This addition of fluid need not occur, in certain instances, until the combination is put into service, but may occur earlier.

The invention will now be described with regard to one particular embodiment and a mode of practicing it, which meets or exceeds the EPA requirements for microbiological filters. A typical specific embodiment of filtration apparatus containing the composite purification material of the invention, which incorporates a porous composite material filter. A removable housing is mated with a cap, the cap having an inflow orifice and an outflow orifice. A water supply conduit is joined to the inflow orifice to deliver non-treated water into the device, and a water discharge conduit is joined to the outflow orifice to conduct treated water from the device. Water passes into the housing and the pressure of the water flow forces it through the porous composite material filter member, which is formed in the shape of hollow cylinder with an axial bore, the treated water passing into the axial bore which connects to the outflow orifice. It is to be understood that other configurations where water is caused to pass through a porous filter composite material (which may have different geometrical shapes and/or different flow properties) are contemplated to be within the scope of the invention. The composite material is formed by placing both expanding and non-expanding media between two capped porous tubes of which the outer tube limits the outer diameter and the inner tube is the central bore. Both tubes are chosen to have a pore size smaller than the particles used. In this specific embodiment the pore size of the tubes is less than 300 microns and the tube composition is polyethylene.

Two embodiments where the composite purification material of the invention is used in the form of a sheet or film are envisioned. A composite purification material used in connection with normal flow-through filtration has the fluid being filtered by passage through the sheet or film. Alternatively a composite purification material can be used in connection with crossflow filtration.

### EXAMPLE 1

As an example of a fully functional device, a cylindrical filter composite was prepared with a material composition of approximately 48.75% BRIMAC 216 bone char obtained from Tate and Lyle, approximately 48.75% granular activated carbon, and approximately 2.5% expanding matter material consisting of sodium polyacrylic acid obtained from Chemdal (a lithium counterion could also be used).

The cylindrical or toroidally shaped composite material was approximately 9.8 inches in length, with an outer diameter of approximately 2.5 inches and an inner diameter (the bore) of approximately 1.25 inches. This shape filter fits into a standard water filtration housing used in the home and industrial settings. The filter material had a resistance of about 300 Ω. The outer container which provides structural support for the particulate media is composed of porous polyethylene obtained from Porex. The tube is capped at the bottom and an appropriate fitting is provided at the top for connection the cap of the canister. This prototype was tested and found to reduce both food coloring in water as well as removing chlorine from water.

### EXAMPLE 2

The filter prepared in Example 1 is challenged by exposing it to tap water that is filtered with activated carbon and is then seeded with 2.3×10⁸ colony forming units per liter of E. coli bacteria and 1.0×10⁷ plaque forming units per liter of poliovirus type 1. The seeded water is passed through the filter composite material at a flow rate of approximately 2 liters/minute for 3 minutes, followed by collection of a 500 ml effluent sample. E. coli is assayed on m-Endo agar plates by membrane filtration procedure, while the poliovirus type 1 is assayed by the plaque forming method on BGM cells.

### EXAMPLE 3

As example of a fully functional device, a cylindrical filter composite was prepared with a material composition of 97.5% KDF, a commercially available material composed of fine brass particles, and approximately 2.5% expanding matter material consisting of sodium polyacrylic acid from Chemdal.

The cylindrical or toroidally shaped composite material was approximately 9.8 inches in length, with an outer diameter of approximately 2.5 inches and an inner diameter (the bore 18) of approximately 1.25 inches. This shape filter fits into a standard water filtration housing used in the home and industrial settings. The filter material had a resistance of about 300 Ω. The outer container which provides structural support for the particulate media is composed porous polyethylene obtained from Porex. The tube is capped at the bottom and an appropriate fitting is provided at the top for connection the cap of the canister.

### EXAMPLE 4

The filter prepared in Example 3 is challenged by exposing it to tap water that is filtered with activated carbon and is then seeded with 2.3×10⁸ colony forming units per liter of E. coli bacteria and 1.0×10⁷ plaque forming units per liter of poliovirus type 1. The seeded water is passed through the filter composite material at a flow rate of approximately 2 liters/minute for 3 minutes, followed by collection of a 500 ml effluent sample. E. coli is assayed on m-Endo agar plates by membrane filtration procedure, while the poliovirus type 1 is assayed by the plaque forming method on BGM cells.

### EXAMPLE 5

The filter prepared in Example 1 was challenged by exposing it to tap water containing chlorine. The chlorine concentration reduction in the circulating water was quantitated using a commercial chlorine (pool) colorimetric test kit. The Chlorine level in the water (10 gallons) was increased by the addition of sodium hypochlorite to between 10 and 20 ppm. After recirculating the water through the filter for several minutes chlorine levels were undetected.

As described above, the composite material of the invention is extremely useful in the area of water purification, particularly the area of drinking water purification. Because of the extremely high efficiency with which the material of the present invention removes microorganisms from water, it meets and exceeds the EPA guidelines for materials used as microbiological water purifiers. In addition to functioning as a purifier for drinking water, the material of the invention can also be used to purify water used for recreational purposes, such as water used in swimming pools, hot tubs, and spas.

As the result of the ability of the material of the invention to efficiently remove and immobilize microorganisms and other cells from aqueous solutions, it has numerous applications in the pharmaceutical and medical fields. For example, the material of the invention can be used to fractionate blood by separating blood components, e.g., to separate plasma from blood cells, and to remove microorganisms from other physiological fluids. The invention may be used to generate materials capable of providing materials for reverse osmosis techniques.

The material can also be used in hospital or industrial areas requiring highly purified air having extremely low content of microorganisms, e.g., in intensive care wards, operating theaters, and clean rooms used for the therapy of immunosuppressed patients, or in industrial clean rooms used for manufacturing electronic and semiconductor equipment.

The material of the invention has multiple uses in fermentation applications and cell culture, where it can be used to remove microorganisms from aqueous fluids, such as fermentation broths or process fluids, allowing these fluids to be used more efficiently and recycled, e.g., without cross-contamination of microbial strains. In addition, because the material is so efficient at removing microorganisms and at retaining them once removed, it can be used as an immobilization medium for enzymatic and other processing requiring the use of microorganisms. A seeding solution containing the desired microorganisms is first forced through the material of the invention, and then substrate solutions, e.g., containing proteins or other materials serving as enzymatic substrates, are passed through the seeded material. As these substrate solutions pass through the material, the substrates dissolved or suspended therein come into contact with the immobilized microorganisms, and more importantly, with the enzymes produced by those microorganisms, which can then catalyze reaction of the substrate molecules. The reaction products may then be eluted from the material by washing with another aqueous solution.

The material of the invention has numerous other industrial uses, e.g., filtering water used in cooling systems. Cooling water often passes through towers, ponds, or other process equipment where microorganisms can come into contact with the fluid, obtain nutrients and propagate. Microbial growth in the water is often sufficiently robust that the process equipment becomes clogged or damaged and requires extensive chemical treatment. By removing microorganisms before they are able to propagate substantially, the present invention helps to reduce the health hazard associated with the cooling fluids and the cost and dangers associated with chemical treatment programs.

Similarly, breathable air is often recycled in transportation systems, either to reduce costs (as with commercial airliners) or because a limited supply is available (as with submarines and spacecraft). Efficient removal of microorganisms permits this air to be recycled more safely. In addition, the material of the invention can be used to increase indoor air quality in homes or offices in conjunction with the air circulation and conditioning systems already in use therein. The composite purification material of the invention can also be used to purify other types of gases, such as anesthetic gases used in surgery or dentistry (e.g., nitrous oxide), gases used in the carbonated beverage industry (e.g., carbon dioxide), gases used to purge process equipment (e.g., nitrogen, carbon dioxide, argon), and/or to remove particles from surfaces, etc.

The composite materials of the invention may be used to generate catalytic devices based upon chemicals such as metals and biochemical such as enzymes. These devices may be used to treat or remediate emission gases such as those generated by the chemical, mining, power, and manufacturing industries as well as those generated from consumer products such as those powered with combustion engines.

In each of these applications, the method of using the material of the invention is relatively simple and should be apparent to those of skill in the filtration art. The fluid to be filtered is simply conducted to one side of a composite material or sheet of material of the invention, typically disposed in some form of housing, and forced through the material as the result of a pressure drop across the composite purification material. Purified, filtered fluid is then conducted away from the “clean” side of the filter and further processed or used.

The invention having been thus described by reference to certain of its specific embodiments, it will be apparent to those of skill in the art that many variations and modifications of these embodiments may be made within the spirit of the invention, which are intended to come within the scope of the appended claims and equivalents thereto.

What is claimed is:

1. A porous composite purification material for filtering fluids, comprising a particulate fluid treatment material and an expandable material that swells sufficiently in the presence of a fluid to immobilize the particulate fluid treatment material wherein the composite material contains pores through which fluid may pass.

2. The composite purification material of claim 1, in the form of a porous block composite material.

3. The composite purification material of claim 2, wherein the porous block composite material takes the form of the container or support structure.

4. The composite purification material of claim 1, in the form of a porous linear sheet.

5. The composite purification material of claim 4, wherein the porous sheet takes the form of the container or support structure.

6. The composite purification material of claim 4, wherein the porous sheet and container are flexible.

7. The composite purification material of claim 1, wherein at least a portion of said expandable material is superabsorbent.

8. The composite purification material of claim 7, wherein the superabsorbent comprises a polymer material.

9. The composite purification material of claim 8, wherein the superabsorbent is a crosslinked polymer having a degree of crosslinking ranging from about 1% to about 99%.

10. The composite purification material of claim 9, wherein the polymer is stable under sterilization conditions.

11. The composite purification material of claim 8, wherein said superabsorbent comprises a material selected from the group consisting of polyacrylic acids, polyacrylamides, poly-alcohols, polyamines, polyethylene oxides, cellulose, chitins, gelatins. starch, polyvinyl alcohols and polyacrylic acid, polyacrylonitrile, carboxymethyl cellulose, alginic acids, carrageenans isolated from seaweeds, polysaccharides, pectins, xanthans, poly-(diallyldimethylammonium chloride), poly-vinylpyridine, poly-vinylbenzyltrimethylammonium salts, polyvinylacetates, and polylactic acids or a combination thereof.

12. The composite purification material of claim 7, wherein the superabsorbent comprises a material selected from the group consisting of resins obtained by polymerizing acrylic acid and resins obtained by polymerizing acrylamide.

13. The composite purification material of claim 8, wherein the polymer material comprises a naturally occurring polymer, cellulose, alginic acids, carrageenans isolated from seaweeds, polysaccharides, pectins, xanthans, starch, and combinations thereof.

14. The composite purification material of claim 7, wherein the superabsorbent material comprises an ionically charged surface.

15. The composite purification material of claim 14, wherein the superabsorbent material comprises an ionically charged surface ranging from 1-100% of the material surface.

16. The composite purification material of claim 13, wherein the naturally occurring polymer is selected from the group consisting of natural and synthetically modified celluloses, collagens, and organic acids.

17. The composite purification material of claim 8, wherein the superabsorbent material comprises a biodegradable polymer.

18. The composite purification material of claim 7, wherein the superabsorbent material comprises a clay or aluminosilicate material.

19. The composite purification material of claim 7, wherein the superabsorbent material comprises is bentonite.

20. The composite purification material of claim 16, wherein the naturally occurring polymer is a biodegradable polymer selected from the group consisting of a polyethyleneglycol, a polylactic acid, a polyvinylalcohol, a co-polylactideglycolide, cellulose, alginic acids, carrageenans isolated from seaweeds, polysaccharides, pectins, xanthans, starch, and combinations thereof.

21. The composite purification material of claim 8, wherein the composite purification material is in the form of a sheet and is disposed on a woven web.

22. The composite purification material of claim 8, wherein the composite purification material is in the form of a sheet and is disposed on a nonwoven web.

23. The composite purification material of claim 7, wherein the superabsorbent is present in an amount ranging from about 0.1 wt % and about 99.9 wt % of the total weight of the composite purification material.

24. The composite purification material of claim 1, further comprising one or more additional adsorptive materials from the group consisting of absorptive resins, activated carbon, activated alumina, apatite, metal particulates, and ores.

25. The composite purification material of claim 24, wherein said additional adsorptive material comprises granulated activated charcoal.

26. The composite purification material of claim 25, further comprising apatite in the form of bone char.

27. The composite purification material of claim 26, wherein said bone char and said granulated charcoal are present in approximately equal amounts.

28. The composite purification material of claim 27, wherein said bone char and said activated carbon are each present in amounts of about 48.75 wt %, and said expanding material is present in an amount of about 2.5 wt %, based upon the total weight of said composite purification material.

29. The composite purification material of claim 1, further comprising an adsorptive material that comprises an ion-binding material selected from the group consisting of synthetic ion exchange resins, zeolites, aluminum minerals, and phosphate minerals.

30. The composite purification material of claim 29, wherein the phosphate minerals are members of the apatite group of minerals.

31. The composite purification material of claim 29, wherein the alumina minerals are members of the aluminum class of minerals.

32. The composite purification material of claim 29, wherein the synthetic ion exchange resins are functionalized styrenes, vinylchlorides, divinyl benzenes, methacrylates, acrylates, and mixtures, copolymers, and blends thereof.

33. The composite purification material of claim 29, wherein the zeolite is a silicate containing mineral known as clinoptilolite.

34. The composite purification material of claim 1, further comprising one or more materials that undergo an oxidation or a reduction in the presence of water or aqueous fluid.

35. A device for filtering microbiological contaminants from water or aqueous fluid, comprising:
a housing;
a porous composite material of the composite purification material of claim 1.

36. The device according to claim 35, wherein the housing comprises an inlet, an outlet, and a contacting chamber there between, and wherein said porous composite material is disposed within the contacting chamber, such that fluid can flow into the housing from the inlet passes through the porous composite material and then can flow out of the housing through the outlet.

37. A method for filtering a fluid to remove any microorganisms therefrom, comprising causing the fluid to flow through the composite purification material of claim 1, thereby obtaining filtered fluid.

38. The method of claim 37, wherein said fluid is water.

39. The method of claim 38, wherein the filtered water is potable.

40. The method of claim 37, wherein said fluid is an aqueous solution.

41. The method of claim 40, wherein said aqueous solution is blood.

42. The method of claim 40, wherein said aqueous solution is a fermentation broth.

43. The method of claim 40, wherein said aqueous solution is a recycled stream in a chemical or biological process.

44. The method of claim 40, wherein the aqueous solution is a recycled stream in a cell culturing process.

45. The method of claim 40, wherein the aqueous solution has been used in a surgical procedure.

46. The method of claim 37, wherein the fluid comprises breathable air.

47. The method of claim 37, wherein the fluid comprises a purge gas.

48. The method of claim 47, wherein the purge gas is selected from the group consisting of O₂CO₂, N₂, or Ar.

49. The method of claim 37, wherein the fluid is an anesthetic gas.

50. The method of claim 49, wherein the anesthetic gas comprises nitrous oxide.

51. The method of claim 37, further comprising regenerating said composite purification material by sterilization.

52. The method of claim 51, wherein said sterilization comprises exposing the composite purification material to elevated temperature, pressure, radiation levels, or chemical oxidants or reductants, or a combination thereof.

53. The method of claim 52, wherein said sterilization comprises autoclaving.

54. The method of claim 52, wherein said sterilization comprises electrochemical treatment.

55. The method of claim 52, wherein said sterilization comprises a combination of chemical oxidation and autoclaving.

56. The method of claim 37, wherein said fluid is a gaseous mixture.

57. The method of claim 56, wherein the filtered gas is air.

58. The method of claim 37, wherein said fluid is a chemically unreactive gas.

59. The method of claim 58, wherein said gas is oxygen, carbon dioxide, nitrogen, argon, or nitrogen oxides.

60. The method of claim 58, wherein said gas is used to pressurize a chamber.

61. The method of claim 58, wherein said gas is used to sparge or purge an aqueous solution for the purpose of increasing the concentration of the sparging gas in the solution.

62. The method of claim 58, wherein said gas is used to sparge or purge an aqueous solution for the purpose of decreasing the concentration of the gases initially present in the solution.

63. The method of claim 58, wherein said gas is used to remove particulate material from surfaces.

64. An immobilization and contacting medium for microorganisms, comprising apatite and an expanding material that swells sufficiently in the presence of a fluid to immobilize the apatite which is in the form of a rigid, porous composite material or a sheet.

65. The immobilization and contacting medium of claim 64, further comprising one or more microorganisms disposed within the pores thereof.

66. The composite purification material of claim 7 where the superabsorbent material functions as a water fluid treatment media.

67. The composite purification material of claim 7 where the superabsorbent is a copolymer.

68. The composite purification material of claim 1 further comprising a catalyst for chemical conversion of a chemical processing stream.
